(19) United States
(12) Patent Application Publication
(10) Pub. No.: US 2015/0360394 A1
(43) Pub. Date: Dec. 17, 2015

(54) IMPRINT APPARATUS, IMPRINT METHOD, METHOD OF MANUFACTURING ARTICLE, AND SUPPLY APPARATUS

(71) Applicant: CANON KABUSHIKI KAISHA, Tokyo (JP)

(72) Inventors: Keiji Yamashita, Utsunomiya-shi (JP); Youji Kawasaki, Utsunomiya-shi (JP)

(21) Appl. No.: 14/737,967

(22) Filed: Jun. 12, 2015

(30) Foreign Application Priority Data
Jun. 13, 2014 (JP) 2014-122742

(51) Int. Cl. B29C 31/04; B29C 59/02

(52) U.S. Cl. CPC B29C 31/042; B29C 59/02; B29K 2101/00

(57) ABSTRACT

The present invention provides an imprint apparatus which molds an imprint material on a substrate using a mold to form a pattern on the substrate, the apparatus including a dispenser configured to discharge the imprint material from a discharge outlet, and a gas supply unit configured to supply a gas which dissolves in the imprint material and decreases a viscosity of the imprint material, wherein the gas supply unit causes the gas to dissolve in the imprint material around the discharge outlet and decreases the viscosity of the imprint material around the discharge outlet, by supplying the gas to the discharge outlet.

### BACKGROUND OF THE INVENTION

1. Field of the Invention

The present invention relates to an imprint apparatus, an imprint method, a method of manufacturing an article, and a supply apparatus.

2. Description of the Related Art

As a request for micropatterning of a semiconductor device, a MEMS, or the like increases, a microfabrication technique of molding a resin (imprint material) on a substrate using a mold (die) to form a resin pattern on the substrate has received attention, in addition to a conventional photolithography technique. The technique is called an imprint technique and can form a fine structure (pattern) of several nm order on the substrate. A photo-curing method is one example of the imprint technique.

In an imprint apparatus which adopts the photo-curing method, first, a photocuring resin is supplied (applied) to a shot region on the substrate and the resin (uncured resin) is molded using the mold. Then, the resin is irradiated with light and cured, and the mold is released from the cured resin on the substrate, thereby forming the resin pattern on the substrate. A thermal curing method which applies heat in a state in which the mold and the resin on the substrate are in contact with each other, and cures the resin is also known as a resin curing method other than the photocuring method.

The imprint apparatus generally adopts a step-and-repeat method. Note that the “step-and-repeat method” is a method of moving the substrate step by step every time the pattern is formed at once in the shot region on the substrate and moving to a next shot region. However, since the viscosity of the resin supplied to the substrate is low, it is difficult in the imprint apparatus to move the substrate in a state in which the resin is applied to the substrate in advance as in an exposure apparatus. To cope with this, U.S. Pat. No. 7,077,992 proposes a dispense method of discharging (supplying), using a dispenser (nozzle), the resin to the substrate every time the mold is pressed when forming a pattern in each shot region.

In the dispense method, a foreign substance such as a fine particle or a bubble generated by solidification (curing) of the resin or the like may cause nozzle clogging. Because of this, the resin is not discharged from the nozzle (discharge failure), the resin is not discharged vertically from the nozzle, or the like, thereby causing a decrease in discharge accuracy. As a result, a reduction in uniformity of RLT (Residual Layer Thickness) of the resin pattern formed on the substrate or an unfilling defect may be caused. Therefore, the nozzle needs to be cleaned (washed) when nozzle clogging occurs. Japanese Patent Laid-Open No. 2008-302306 proposes a technique concerning such nozzle cleaning.

The technique concerning nozzle cleaning generally includes a technique of discharging the resin repeatedly to improve nozzle clogging or a technique of forcibly applying a pressure to the nozzle to push out the resin. In such a technique, however, a large amount of resin is consumed or a long time is required for nozzle clogging to be improved.

Japanese Patent Laid-Open No. 2008-302306 proposes a technique of driving a piezoelectric element at a frequency higher than a frequency at which the piezoelectric element is actually used to remove a foreign substance in the nozzle in a state in which the nozzle is dipped in a solvent. However, if the nozzle is dipped in the solvent as in Japanese Patent Laid-Open No. 2008-302306, a step of wiping the solvent which adheres to the surface (discharge surface) of the nozzle is needed. Since such a step is added, a long time may be needed for nozzle cleaning. Additionally, the foreign substance may adhere to the discharge surface of the nozzle when wiping the solvent.

### SUMMARY OF THE INVENTION

The present invention provides an imprint apparatus advantageous in cleaning a dispenser.

According to one aspect of the present invention, there is provided an imprint apparatus which molds an imprint material on a substrate using a mold to form a pattern on the substrate, the apparatus including a dispenser configured to discharge the imprint material from a discharge outlet, and a gas supply unit configured to supply a gas which dissolves in the imprint material and decreases a viscosity of the imprint material, wherein the gas supply unit causes the gas to dissolve in the imprint material around the discharge outlet and decreases the viscosity of the imprint material around the discharge outlet, by supplying the gas to the discharge outlet.

Further aspects of the present invention will become apparent from the following description of exemplary embodiments with reference to the attached drawings.

### BRIEF DESCRIPTION OF THE DRAWINGS

FIG. 1 is a schematic view showing the arrangement of an imprint apparatus according to an aspect of the present invention.

FIG. 2 is a schematic sectional view showing the arrangement of a cleaning unit according to the first embodiment.

FIG. 3 is a flowchart for explaining a cleaning process of a dispenser.

FIG. 4 is a schematic sectional view showing the arrangement of a cleaning unit according to the second embodiment.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

### First Embodiment

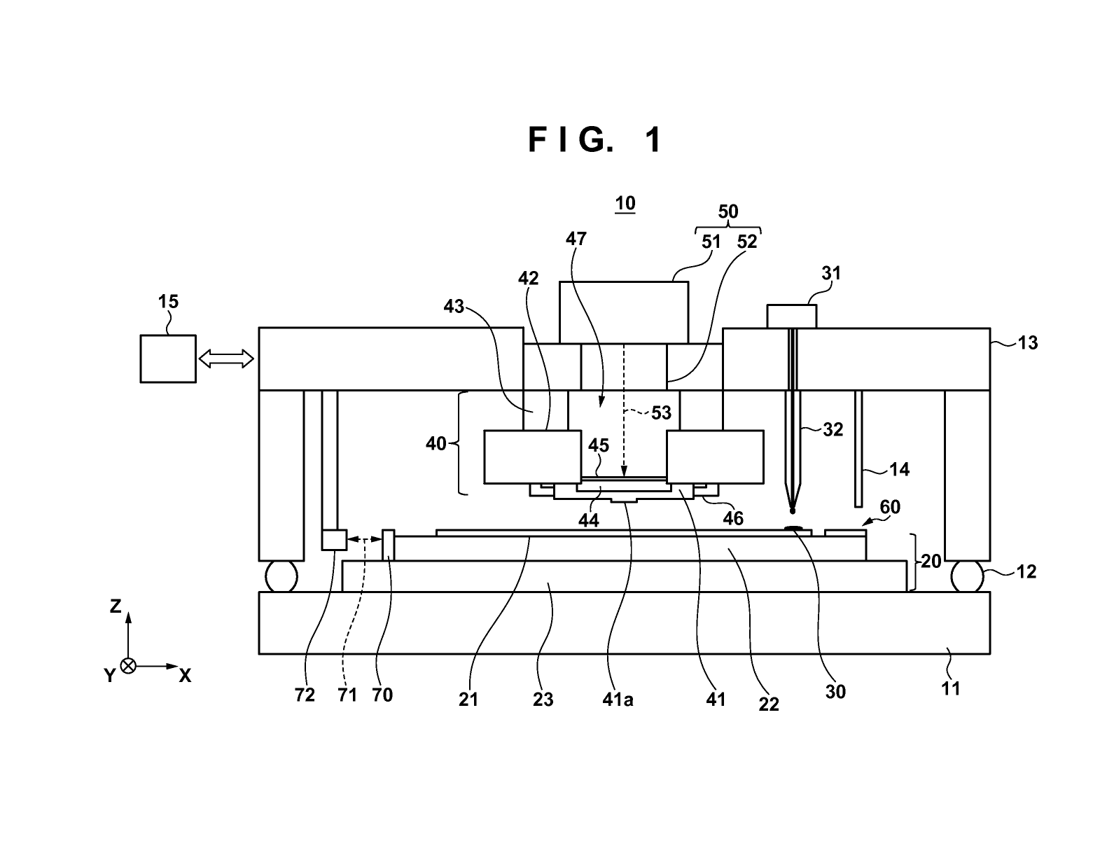

FIG. 1 is a schematic view showing the arrangement of an imprint apparatus 10 according to an aspect of the present invention. The imprint apparatus 10 is a lithography apparatus used for manufacturing a device such as a semiconductor device as an article. The imprint apparatus 10 performs an imprint process in which an imprint material on a substrate is molded using a mold to form a pattern on the substrate.

The imprint apparatus 10 adopts a photo-curing method and uses, as the imprint material, an ultraviolet-curing resin which is cured by ultraviolet irradiation. However, the imprint apparatus 10 may adopt a thermal curing method. In the following description, a direction parallel to the optical axis of an ultraviolet beam which irradiates the resin on the substrate will be referred to as the Z-axis, and directions perpendicular to each other in a plane perpendicular to the Z-axis will be referred to as the X-axis and the Y-axis.

The imprint apparatus 10 includes an irradiation unit 50, a mold holding unit 40, a substrate holding unit 20, a dispenser 32, a control unit 15, and a cleaning unit 60. The imprint apparatus 10 also includes a platen 11, antivibrators 12, a frame 13, and an alignment scope 14. The platen 11 supports the entire imprint apparatus 10 and forms a reference plane for the movement of a substrate stage 23. Each antivibrator 12 supports the frame and has a function of removing a vibration from a floor. The frame 13 supports respective units arranged above a substrate 21, or more specifically, the units from a light source 51 to a mold 41. The alignment scope 14 measures the position of an alignment mark provided on the substrate 21. The substrate stage 23 is positioned based on a measurement result by the alignment scope 14.

The irradiation unit 50 irradiates a resin 30 on the substrate with an ultraviolet beam 53 via the mold 41 in the imprint process, or more specifically, when curing the resin 30. The irradiation unit 50 includes the light source 51 and an optical system 52 configured to appropriately adjust the ultraviolet beam 53 emitted from the light source 51 to irradiate the resin 30.

The light source 51 can adopt a lamp such as a halogen lamp. However, the light source 51 is not specifically limited to it as long as the light source emits light which can be transmitted through the mold 41 and has a wavelength capable of curing the resin 30. The optical system 52 includes a lens, a mirror, an aperture, a shutter configured to switch between irradiation and shielding of the ultraviolet beam 53, and the like.

In this embodiment, the imprint apparatus 10 adopts the photo-curing method, and thus includes the irradiation unit 50. However, for example, if the imprint apparatus 10 adopts the thermal curing method, the irradiation unit 50 is replaced with a heat source unit which provides heat for setting a thermosetting resin.

The mold 41 has the outer shape of a polygon (for example, a rectangular or a square) and includes a pattern portion 41a where a concave-convex pattern (circuit pattern) that should be transferred onto the substrate 21 is formed three-dimensionally on a surface facing the substrate 21. The mold 41 is made of a material such as quartz capable of transmitting the ultraviolet beam 53. Furthermore, the mold 41 has a circular planar shape on an incident surface where the ultraviolet beam 53 enters and a cavity (concave portion) 44 having a certain degree of depth.

The mold holding unit 40 includes a mold chuck 42 which holds the mold 41, a mold driving mechanism 43 which holds the mold chuck 42 to be movable, and a correction mechanism 46 which corrects the shape of the mold 41 (pattern portion 41a).

The mold chuck 42 holds the mold 41 by chucking the peripheral region of the incident surface of the ultraviolet beam 53 of the mold 41 by a vacuum suction force or an electrostatic force. For example, when the mold 41 is held by the vacuum suction force, the mold chuck 42 is connected to an externally provided vacuum pump (not shown) and adjusts a suction force generated by air exhaust of the vacuum pump as needed, thereby adjusting the suction force (holding force) with respect to the mold 41.

The mold driving mechanism 43 moves the mold chuck 42 (mold 41) in each axis direction so as to selectively press the mold 41 against the resin 30 on the substrate or release the mold 41 from the resin 30 on the substrate. A power source that can be adopted to the mold driving mechanism 43 includes, for example, a linear motor or an air cylinder. The mold driving mechanism 43 may be constituted by a plurality of driving systems such as a coarse driving system and a fine driving system so as to position the mold 41 at high accuracy. The mold driving unit 43 may have a position adjustment function not only in the Z-axis direction but also in the X-axis direction, the Y-axis direction, and the 0 direction (rotational direction around the Z-axis), and a tilt function of correcting the tilt of the mold 41.

Respective operations of pressing and releasing the mold 41 in the imprint apparatus 10 may be implemented by moving the mold 41 in the Z-axis direction. However, they may be implemented by moving the substrate 21 in the Z-axis direction. Alternatively, the respective operations of pressing and releasing the mold 41 may be implemented by moving both of the mold 41 and the substrate 21 relatively in the Z-axis direction.

The correction mechanism 46 is provided on the holding side of the mold 41 in the mold chuck 42 and has a function of deforming the mold 41. The correction mechanism 46 corrects the shape of the mold (pattern portion 41a) by mechanically applying an external force or a deformation to the side surface of the mold 41.

The mold chuck 42 and the mold driving mechanism 43 include, in their central portion (inside), an opening region 47 which enables the ultraviolet beam 53 emitted from the irradiation unit 50 toward the substrate 21 to pass. Note that the mold chuck 42 (or the mold driving mechanism 43) may include a light-transmissive member (for example, a glass plate) 45 for making the cavity 44 surrounded by a portion of the opening region 47 and the mold 41 be an enclosed space. In this case, a pressure regulating device (not shown) including the vacuum pump or the like regulates the internal pressure of the cavity 44. The pressure regulating device, for example, sets the internal pressure of the cavity 44 to be higher than the external pressure when pressing the mold 41 against the resin 30 on the substrate. This makes it possible to flex (deform) the pattern portion 41a of the mold 41 into a convex shape toward the substrate 21 and contact the resin 30 on the substrate from the central portion of the pattern portion 41a. As a result, a gas (air) is prevented from remaining between the resin 30 and the pattern portion 41a of the mold 41, and thus the pattern portion 41a can efficiently be filled with the resin 30.

The substrate 21 includes, for example, a single-crystal silicon substrate or SOI (Silicon On Insulator) substrate. The pattern (a layer including the pattern) of the resin 30 corresponding to the pattern portion 41a of the mold 41 is formed in a plurality of shot regions (pattern formation regions) on the substrate 21. In general, a pattern (substrate-side pattern) is formed, in a preceding step, in the plurality of shot regions on the substrate 21 loaded into the imprint apparatus 10.

The substrate holding unit 20 holds the substrate 21 to be movable and is used, for example, to perform alignment between the pattern portion 41a and the shot regions (substrate-side patterns) on the substrate 21 when bringing the mold 41 and the resin 30 on the substrate into contact with each other. The substrate holding unit 20 includes a substrate chuck 22 which holds (chucks) the substrate 21 and a substrate stage 23 which mechanically holds and moves the substrate chuck 22 in each axis direction.

The power source that can be adopted to the substrate stage 23 includes, for example, the linear motor or a planar motor. The substrate stage 23 may be constituted by a plurality of driving systems such as the coarse driving system and the fine driving system in the X-axis direction and the Y-axis direction. The substrate stage 23 may have a position adjustment function in the Z-axis direction of the substrate 21, a position adjustment function in the θ-axis direction of the substrate 21, and a tilt function of correcting the tilt of the substrate 21.

A plurality of reference mirrors 70 corresponding to the respective directions of X, Y, Z, ωx, ωy, and ωz are arranged on the side surface of the substrate holding unit 20. The imprint apparatus 10 also includes a plurality of interferometers 72 configured to measure the position of the substrate stage 23, that is, the position of the substrate 21 by irradiating each of these reference mirrors 70 with measurement light 71. However, FIG. 1 only shows a pair of the reference mirror 70 and the interferometer 72. The interferometer 72 measures the position of the substrate 21 in real time. The control unit 15 positions the substrate 21 (substrate stage 23) based on a measurement result by the interferometer 72. In addition to the interferometer 72, an encoder using a semiconductor laser or the like can be adopted as such a measuring device which measures the position of the substrate 21.

The dispenser 32 is provided in proximity to the mold holding unit 40. The dispenser 32 supplies (applies) the resin 30 onto the substrate 21, or more specifically, to the shot regions (substrate-side patterns) on the substrate 21. Note that the resin 30 is the ultraviolet-curing resin which is cured by irradiation with the ultraviolet beam 53 and is selected appropriately in accordance with various conditions such as the manufacturing step of a device. A container 31 which contains the resin 30 in an uncured state is connected to the dispenser 32. The resin 30 is supplied from the container 31 to the dispenser 32.

The dispenser 32 is constituted by, for example, a piezoelectric discharge mechanism (nozzle). The amount of the resin 30 discharged (applied) from the dispenser 32 can be set in a range of 0.1 to 10 [pL/drop] and normally set to about 2 [pL/drop]. The total amount of the resin 30 discharged onto the substrate 21 is determined based on the density of the pattern portion 41a of the mold 41 or a Residual Layer Thickness (RLT) that should be formed on the substrate 21. The dispenser 32 controls, under the control of the control unit 15, the discharge position, the discharge amount, or the like of the resin 30 with respect to the substrate 21.

The control unit 15 is constituted by, for example, a computer including a CPU and a memory, and controls the whole (an operation, an adjustment, and the like of each unit) of the imprint apparatus 10. The control unit 15 is connected to each unit of the imprint apparatus 10 via a line and controls each unit in accordance with a program or the like. The control unit 15 may be arranged as a part of the imprint apparatus 10 as in this embodiment or may be arranged separately from the imprint apparatus 10.

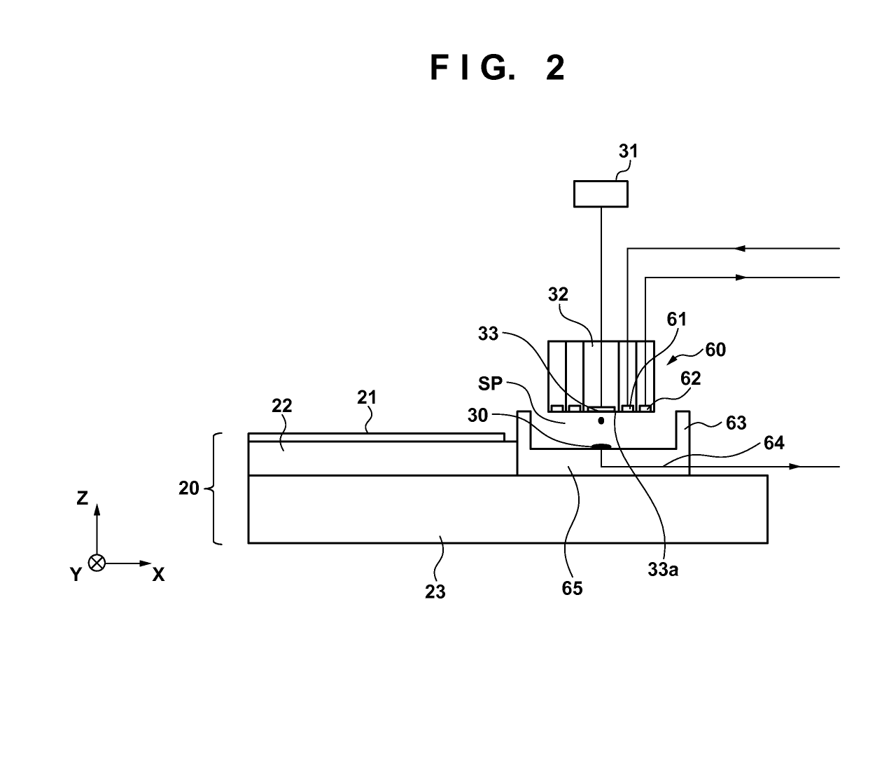

Cleaning (washing) of the dispenser 32 in the imprint apparatus 10 will be described below. FIG. 2 is a schematic sectional view showing the arrangement of a cleaning unit 60 according to the first embodiment. The dispenser 32 includes a discharge outlet 33 configured to discharge the resin 30 toward the substrate 21. The lower surface (outer surface) of the discharge outlet 33 will be referred to as a discharge surface 33a. The cleaning unit 60 has a function of cleaning the dispenser 32, or more specifically, a function of removing clogging of the discharge outlet 33 of the dispenser 32 with the resin 30. The cleaning unit 60 includes, as shown in FIG. 2, a gas supply unit 61, a gas recovery unit (first recovery unit) 62, a barrier 63, a resin recovery unit (second recovery unit) 64, and a receiving portion 65.

The receiving portion 65 functions as a receiving tray which receives the resin 30 discharged from the dispenser 32. The receiving portion 65 is formed from a plate-shaped member and provided on the substrate stage 23. In this embodiment, the gas supply unit 61 is provided to surround the periphery of the dispenser 32. The gas supply unit 61 supplies a gas which easily dissolves in the resin 30 to a space facing the discharge outlet 33 of the dispenser 32, or more specifically, a space SP between the discharge surface 33a and the receiving portion 65 which is a portion facing the discharge surface 33a. The gas supplied from the gas supply unit 61 dissolves in the resin 30, thereby reducing the viscosity of the resin 30 and has a viscosity lower in a liquid state than that of the resin 30. Furthermore, the gas supplied from the gas supply unit 61 has solubility of 0.2 mol/liter or more in the resin 30 in an environment of 20° C. and at one atmosphere and contains, for example, pentafluoropropane. In this embodiment, the gas recovery unit 62 is provided to surround the periphery of the gas supply unit 61 and recovers the gas supplied to the space SP by the gas supply unit 61. The barrier 63 is provided in the peripheral portion of the receiving portion 65 and reduces the leakage of the gas supplied to the space SP by the gas supply unit 61 to the outside of the space SP. The resin recovery unit 64 recovers the resin 30 discharged from the dispenser 32 and received by the receiving portion 65.

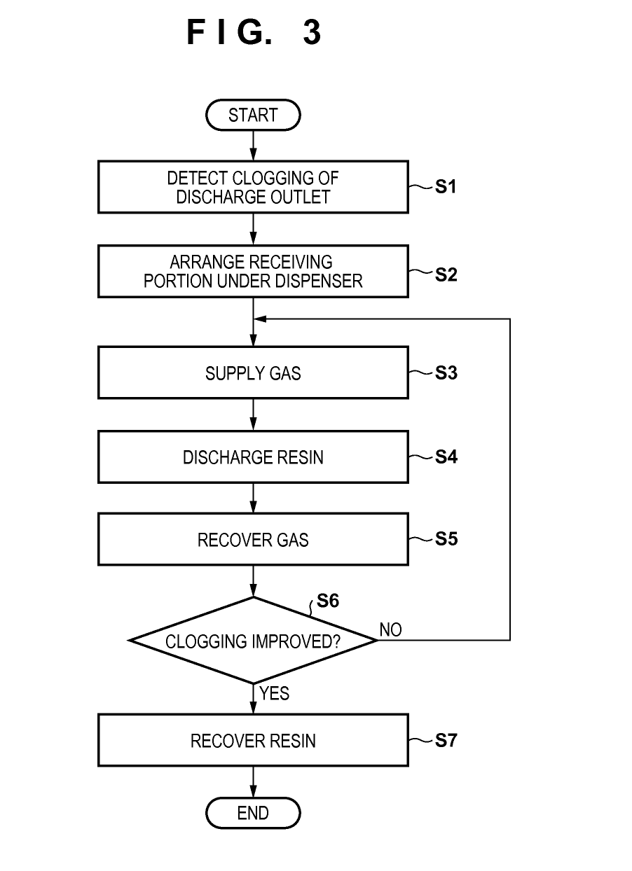

A cleaning process of the dispenser 32 in the imprint apparatus 10 will be described with reference to FIG. 3. The cleaning process of the dispenser 32 is a process of removing clogging of the discharge outlet 33 of the dispenser 32 with the resin 30 and is performed by comprehensively controlling the respective units (the cleaning unit 60, in particular) of the imprint apparatus 10 by the control unit 15. Subsequent to the cleaning process, the imprint apparatus 10 performs the imprint process in which the resin 30 is supplied onto the substrate using the cleaned dispenser 32, and the resin 30 on the substrate is molded using the mold 41 to form the pattern on the substrate.

In step S1, clogging of the discharge outlet 33 of the dispenser 32 is detected. Clogging of the discharge outlet 33 of the dispenser 32 can be detected by regularly discharging the resin 30 from the discharge outlet 33 as a dummy.

In step S2, the receiving portion 65 of the cleaning unit 60 is arranged, by moving the substrate stage 23, under the dispenser 32, or more specifically, to face the discharge surface 33a of the dispenser 32.

In step S3, the gas supply unit 61 supplies the gas to the space SP facing the discharge outlet 33 of the dispenser 32, thereby substituting the space SP with the gas supplied from the gas supply unit 61. At this time, the gas supplied from the gas supply unit 61 may adversely affect the respective units of the imprint apparatus 10. Therefore, the gas recovery unit 62 recovers the gas supplied to the space SP by the gas supply unit 61 so as to prevent the gas from leaking outside the space SP.

In step S4, the resin 30 is discharged from the discharge outlet 33 while the gas supply unit 61 supplies the gas to the space SP, that is, in the atmosphere of the gas supplied from the gas supply unit 61. At this time, the gas supplied from the gas supply unit 61 dissolves in the resin 30. The gas supplied from the gas supply unit 61 has a low viscosity. Therefore, the viscosity and the surface tension of the resin 30 in proximity to the discharge outlet 33 of the dispenser 32 are decreased by dissolving the gas in the resin 30. For example, in the case of the resin 30 whose viscosity is 8 [cp] and whose surface tension is 30 [mN/m], its viscosity is decreased to 4 [cp] and its surface tension is decreased to 28 [mN/m] by dissolving pentafluoropropane. Decreases in the viscosity and the surface tension make it easier for the resin 30 to be discharged from the discharge outlet 33 of the dispenser 32. Therefore, clogging of the discharge outlet 33 can be improved (removed) early.

In step S5, the gas supply unit 61 stops supplying the gas to the space SP and the gas recovery unit 62 recovers the gas supplied to the space SP. As described above, the gas recovery unit 62 needs to recover the gas supplied to the space SP in a predetermined period after the gas supply unit 61 stops supplying the gas to the space SP so as to prevent the gas supplied to the space SP by the gas supply unit 61 from leaking outside the space SP.

In step S6, the atmosphere is returned to an atmosphere in which the imprint process is actually performed to determine whether clogging of the discharge outlet 33 of the dispenser 32 is improved. This determination is made by, for example, supplying the resin 30 onto the substrate 21 by the dispenser 32 to check if there is a supply failure or to check the state of the resin 30 supplied onto the substrate 21 using a camera or the like. If clogging of the discharge outlet 33 of the dispenser 32 is not improved, the process returns to step S3 and the above-described process is repeated until clogging of the discharge outlet 33 of the dispenser 32 is improved. On the other hand, if clogging of the discharge outlet 33 of the dispenser 32 is improved, the process advances to step S7.

In step S7, the resin recovery unit 64 recovers the resin 30 accumulated in the receiving portion 65. The resin 30 accumulated in the receiving portion 65 volatilizes. Consequently, the volatile component may adhere to each unit of the imprint apparatus 10 and contaminate the imprint apparatus 10. Therefore, the resin 30 accumulated in the receiving portion 65 needs to be recovered once clogging of the discharge outlet 33 of the dispenser 32 is improved.

As described above, in this embodiment, clogging of the discharge outlet 33 can be reduced (removed) by supplying the gas which dissolves in the resin 30 and decreases the viscosity of the resin 30 to the space SP facing the discharge outlet 33 of the dispenser 32. In this embodiment, the dispenser 32 is cleaned using the gas. Therefore, unlike the case in which a solvent is used, a step of wiping the unnecessary solvent which adheres to the discharge surface 33a of the dispenser 32 is omitted and a time required for cleaning the dispenser 32 can be reduced. In other words, in this embodiment, clogging of the discharge outlet 33 of the dispenser 32 can be improved in a short time and efficiently.

In this embodiment, the receiving portion 65 of the cleaning unit 60 is provided on the substrate stage 23. However, the receiving portion 65 may be provided in another place. Further, the cleaning process of cleaning the dispenser 32 is not necessarily performed on the receiving portion 65, but may be performed in a retract position where the imprint apparatus 10 is arranged when it is set in a stop state for a long time, or on a dummy substrate for the cleaning process or on the substrate 21. Note that if the cleaning process is performed on the substrate 21, at least one shot region out of the shot regions on the substrate 21 is designated as a shot region for the cleaning process. Furthermore, cleaning of the dispenser 32 may be performed not only when detecting clogging of the discharge outlet 33, but also regularly or when the imprint apparatus 10 returns after the apparatus is set in a stop state for a long time shutdown.

### Second Embodiment

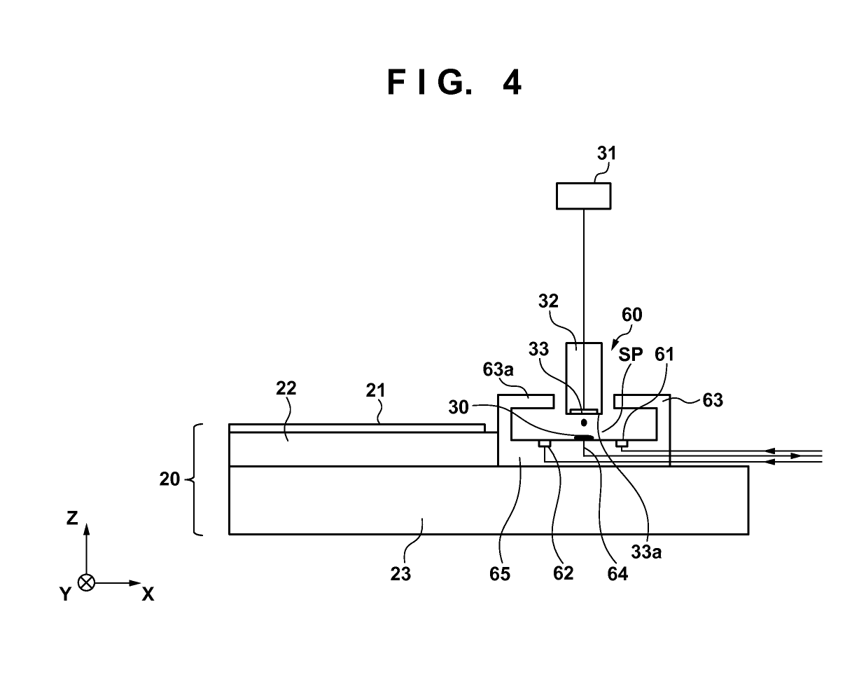

FIG. 4 is a schematic sectional view showing the arrangement of a cleaning unit 60 according to the second embodiment. In the first embodiment, the gas supply unit 61 and the gas recovery unit 62 are provided in the dispenser 32, and the gas is supplied and recovered from the periphery of the dispenser 32. In this embodiment, as shown in FIG. 4, a gas supply unit 61 and a gas recovery unit 62 are provided in a receiving portion 65 to face a discharge surface 33a of a dispenser 32. Therefore, the gas supply unit 61 can blow a gas toward the discharge surface 33a of the dispenser 32 and efficiently reduce clogging of the discharge outlet 33. Furthermore, in this embodiment, a barrier 63 has a structure in which its conductance is decreased so as to prevent the gas supplied to a space SP from leaking outside the space SP. More specifically, the barrier 63 includes a portion 63a which protrudes toward a dispenser side and surrounds the periphery of the dispenser 32 when cleaning the dispenser 32.

A cleaning process of the dispenser 32 in this embodiment is the same as in the first embodiment (FIG. 3), and thus a detailed description thereof will be omitted here. Also in this embodiment, clogging of the discharge outlet 33 of the dispenser 32 can be improved in a short time and efficiently.

The first embodiment and the second embodiment may be combined. Clogging of the discharge outlet 33 can be improved more efficiently by supplying and recovering the gas from a side facing the discharge surface 33a of the dispenser 32 as well as by supplying and recovering the gas from the periphery of the dispenser 32.

### Third Embodiment

A method of manufacturing a device (a semiconductor device, a magnetic storage medium, a liquid crystal display element, or the like) serving as an article will be described. The manufacturing method includes a step of forming a pattern on a substrate (a wafer, a glass plate, a film-like substrate, or the like) using an imprint apparatus 10. The manufacturing method further includes a step of processing the substrate on which the pattern has been formed. The processing step can include a step of removing the residual film of the pattern. The processing step can also include another known step such as a step of etching the substrate using the pattern as a mask. The method of manufacturing the article according to this embodiment is advantageous in at least one of the performance, the quality, the productivity, and the production cost of the article, as compared to conventional methods.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-122742 filed on Jun. 13, 2014, which is hereby incorporated by reference herein in its entirety.

What is claimed is:

1. An imprint apparatus which molds an imprint material on a substrate using a mold to form a pattern on the substrate, the apparatus comprising:
a dispenser configured to discharge the imprint material from a discharge outlet; and
a gas supply unit configured to supply a gas which dissolves in the imprint material and decreases a viscosity of the imprint material,
wherein the gas supply unit causes the gas to dissolve in the imprint material around the discharge outlet and decreases the viscosity of the imprint material around the discharge outlet, by supplying the gas to the discharge outlet.

2. The apparatus according to claim 1, further comprising a first recovery unit configured to recover the gas supplied by the gas supply unit.

3. The apparatus according to claim 1, wherein the dispenser discharges the imprint material while the gas supply unit supplies the gas.

4. The apparatus according to claim 3, further comprising a receiving portion configured to receive the imprint material discharged from the dispenser while the gas supply unit supplies the gas.

5. The apparatus according to claim 1, further comprising a second recovery unit configured to recover the imprint material discharged from the dispenser while the gas supply unit supplies the gas.

6. The apparatus according to claim 1, further comprising a barrier configured to reduce leakage of the gas supplied by the gas supply unit.

7. The apparatus according to claim 6, wherein the barrier includes a portion which protrudes toward a side of the dispenser and surrounds a periphery of the dispenser.

8. The apparatus according to claim 4, further comprising a substrate stage configured to hold the substrate and be movable,
wherein the receiving portion is provided on the substrate stage.

9. The apparatus according to claim 2, wherein the gas supply unit is provided to surround a periphery of the dispenser, and
the first recovery unit is provided to surround a periphery of the gas supply unit.

10. The apparatus according to claim 2, wherein the gas supply unit and the first recovery unit are provided to face the discharge outlet.

11. The apparatus according to claim 10, wherein the gas supply unit blows the gas toward the discharge outlet.

12. The apparatus according to claim 1, wherein the gas has a viscosity lower than the viscosity of the imprint material in a liquid state.

13. The apparatus according to claim 1, wherein a solubility of the gas in the imprint material in an environment of 20° C. and at one atmosphere is not less than 0.2 mol/liter.

14. The apparatus according to claim 1, wherein the gas contains pentafluoropropane.

15. The apparatus according to claim 1, wherein the gas supply unit supplies the gas to a space facing the discharge outlet.

16. An imprint method in an imprint apparatus which includes a dispenser configured to discharge an imprint material from a discharge outlet toward a substrate, the method comprising:
a first step of removing clogging of the discharge outlet with the imprint material; and
a second step of supplying the imprint material onto the substrate using the dispenser in which the clogging is removed in the first step and molding the imprint material on the substrate using a mold to form a pattern on the substrate,
wherein in the first step, the clogging of the discharge outlet with the imprint material is removed by arranging the discharge outlet in an atmosphere of a gas which dissolves in the imprint material and decreases a viscosity of the imprint material.

17. The method according to claim 16, wherein in the first step, the gas is supplied to a space facing the discharge outlet, and
in the second step, supply of the gas to the space is stopped.

18. The method according to claim 16, wherein in the first step, the clogging of the discharge outlet with the imprint material is removed by discharging the imprint material from the discharge outlet in the atmosphere of the gas.

19. A method of manufacturing an article, the method comprising:
forming a pattern on a substrate using an imprint apparatus; and
processing the substrate on which the pattern has been formed,
wherein the imprint apparatus molds an imprint material on the substrate using a mold to form the pattern on the substrate, and includes:
a dispenser configured to discharge the imprint material from a discharge outlet; and
a gas supply unit configured to supply a gas which dissolves in the imprint material and decreases a viscosity of the imprint material,
wherein the gas supply unit causes the gas to dissolve in the imprint material around the discharge outlet and decreases the viscosity of the imprint material around the discharge outlet, by supplying the gas to the discharge outlet.

20. A supply apparatus which supplies a gas to a discharge outlet configured to discharge an imprint material, the apparatus comprising:
a supply port configured to supply a gas which dissolves in the imprint material and decreases a viscosity of the imprint material,
wherein the supply apparatus causes the gas to dissolve in the imprint material around the discharge outlet and decreases a viscosity of the imprint material around the discharge outlet, by supplying the gas to the discharge outlet from the supply port.
